(19) United States
(12) Patent Application Publication
(10) Pub. No.: US 2026/0038180 A1
(43) Pub. Date: Feb. 5, 2026

(54) METHOD OF ENHANCING DATASET FOR USE IN A MEDICAL DIAGNOSTIC SYSTEM, A METHOD FOR TRAINING A MEDICAL DIAGNOSTIC SYSTEM, AND A METHOD OF SYNTHESIZING VIDEO FOR MEDICAL DIAGNOSIS

(71) Applicant: The Chinese University of Hong Kong, New Territories (CN)

(72) Inventors: Yixuan Yuan, Festival City (CN); Wuyang Li, San Po Kong (CN)

(21) Appl. No.: 19/069,744

(22) Filed: Mar. 4, 2025

Related U.S. Application Data
(60) Provisional application No. 63/679,214, filed on Aug. 5, 2024.

(51) Int. Cl. G06T 13/80; G06T 5/60

(52) U.S. Cl. CPC G06T 13/80; G06T 5/60; G06T 2200/28

(57) ABSTRACT

A method of enhancing dataset for use in a medical diagnostic system, a method for training a medical diagnostic system, and a method of synthesizing video for medical diagnosis. The method of enhancing dataset includes the step of: receiving a static medical image capturing a diagnostic target; and generating, based on the received static medical image, a series of video frames arranged to combine to a dynamic video representing a clinical motion of the diagnostic target over a predetermined period of time; wherein the dynamic video is adapted to be included in a medical dataset for training the medical diagnostic system.

### TECHNICAL FIELD

This invention relates to a method of enhancing dataset for use in a medical diagnostic system, a method for training a medical diagnostic system, and a method of synthesizing video for medical diagnosis. Particularly, although not exclusively, the invention relates to a method of boost medical image analysis with generative medical videos.

### BACKGROUND OF THE INVENTION

The explosion of large models has profoundly impacted daily life, which is primarily driven by the extensive data availability. However, acquiring adequate images may be particularly challenging in certain field due to different reasons, posing significant hurdles to developing reliable systems.

In the field of intelligent healthcare, the accessibility of medical data is severely constrained by privacy concerns, high costs, and limited patient cases, and may significantly hindering automated clinical assistance and development of the medical community.

### SUMMARY OF THE INVENTION

In accordance with a first aspect of the present invention, there is provided a method of enhancing dataset for use in a medical diagnostic system, comprising the step of: receiving a static medical image capturing a diagnostic target; and generating, based on the received static medical image, a series of video frames arranged to combine to a dynamic video representing a clinical motion of the diagnostic target over a predetermined period of time; wherein the dynamic video is adapted to be included in a medical dataset for training the medical diagnostic system.

In accordance with the first aspect, the series of video frames are generated by an AI-based video generator.

In accordance with the first aspect, the series of video frames are generated based on augmentation of the static medical image.

In accordance with the first aspect, the step of generating the series of video frames comprises the step of generating N video frames using a stable video diffusion process.

In accordance with the first aspect, the stable video diffusion process is formulated with a Markov chain, arranged to generate video data from noise in the static medical image via a T-step denoising process.

In accordance with the first aspect, a plurality of static medical images are provided as sample images each captures the respective diagnostic target, and wherein the sample images are processed by the stable video diffusion process, to obtained a set of synthesized videos, wherein each of the synthesized video comprises the N video frames generated by the each of the sample images being augmented.

In accordance with the first aspect, the sample images including labelled and unlabeled medical images capturing a respective diagnostic target.

In accordance with the first aspect, the clinical motion includes at least one of spatial translation, liquid flow and shake blur.

In accordance with the first aspect, the method further comprises the step of generating, based on the dynamic video being generated, a series of reversed-generated images embedding inherent motion information associated with the diagnostic target over the predetermined period of time; wherein the series of reversed-generated images is arranged to be included in the medical dataset for training the medical diagnostic system.

In accordance with the first aspect, the method further comprises the step of processing the series of reversed-generated images and the dynamic video using a video-to-image distillation process to distill motion-aware cue information from the dynamic video.

In accordance with the first aspect, the video-to-image distillation process comprises the steps of: scaling up a dimension of each of the series of reversed-generated image embeddings to obtain more representative space; and distilling motion-aware cue information from the dynamic video to associated image frames with a loss function.

In accordance with the first aspect, the method further comprises the step of enhancing cross-image consistency within imaging modality of the series of reversed-generated images.

In accordance with the first aspect, a plurality pairs of reversed-generated images in the series of reversed-generated images associated with each video frame pair in the dynamic video are enhanced via consistency loss.

In accordance with a second aspect of the present invention, there is provided a method for training a medical diagnostic system in accordance with the first aspect, comprising the step of training a classifier with the medical dataset comprising the dynamic video and/or the series of reversed-generated images.

In accordance with the second aspect, the dynamic videos are labelled.

In accordance with the second aspect, the method further comprises the step of training an image encoder arranged to generated the series of reversed-generated image embeddings based on the dynamic video.

In accordance with the second aspect, the classifier and/or the image encoder is a machine learning network.

In accordance with the second aspect, the classifier and/or the image encoder is trained the series of reversed-generated images and embedded with motion-aware cue information, without any video-related components.

In accordance with a third aspect of the present invention, there is provided a method of synthesizing video for medical diagnosis, comprising the step of: providing a static medical image capturing a diagnostic target; and generating a series of video frames using the method in accordance with the first aspect.

In accordance with the third aspect, the method further comprises the step of generating a dynamic video embedding with the series of video frame using a frozen video encoder.

### BRIEF DESCRIPTION OF THE DRAWINGS

FIG. 1 is a schematic diagram of a computer server which is arranged to be implemented as a processor of a medical diagnostic system in accordance with an embodiment of the present invention.

FIG. 2 is a block diagram showing a medical diagnostic system in accordance with an embodiment of the present invention.

FIG. 3A is a block diagram showing a medical diagnostic system training pipeline based on static images.

FIG. 3B is a block diagram showing a medical diagnostic system training pipeline based on static images and generative medical videos in accordance with an embodiment of the present invention.

FIG. 4 is an illustration showing the framework VidMotion, implemented according to a method in accordance with an embodiment of the present invention, in which MUE is a first module which generates medical videos and conducts unbiased sampling, and MCL is the second module which learns motion semantics with images and videos jointly.

FIG. 5 illustrates generative video frames, generated using the method in accordance with an embodiment of the present invention, in which each row represents a 4s video generated from the left-most reference static image, and the generative videos simulate diverse clinical motions including spatial translation, liquid flow, and shake bur.

### DETAILED DESCRIPTION OF THE PREFERRED EMBODIMENTS

The inventors, through their own experiments and trials, devised that data may be scaled up with medical image synthesis, which can broaden the diversity of datasets with generative models. For example, a dual adversarial network may be used to capture essential clinical details with high fidelity. In an alternative example, diffusion models may be employed to achieve style translation, effectively bridging medical domain gaps. In examples focusing on synthesizing tumor cases, great potential in improving tumor detection is observed. Various data types, such as lung CT, retinal, and pathological images, may also be generated for enriching the data resource significantly.

Some methods predominantly focus on synthesizing static images, which may fail to capture the dynamic nature of clinical environments, such as surgical movement and blood flow, undermining the robustness and accuracy of clinical practice. To this end, the inventors devised that diagnosis based on medical videos enriched with motion-based semantics may be more preferable. Advantageously, compared with static imaging, the dynamic nature of videos can model richer and more critical cues, such as subtle movements and the progression of symptoms over time, which are essential for accurate disease identification and monitoring.

In one preferred embodiment, generative medical videos may be used to boost medical image analysis, thereby enabling the perception of clinical motions. However, there are two challenges in achieving such a reliable motion-informed diagnostic. Without wishing to be bound by theory, directly enhancing medical images for all classes equally with generative videos will exacerbate the class imbalance issue, because head classes tend to yield imbalanced video generation, leading to biased diagnoses.

To tackle the challenge, a novel method in accordance with embodiments of the present invention, that is also named as “VidMotion”, is provided to boost medical image analysis with video-driven motion.

The terminology used herein is for the purpose of describing particular embodiments only and is not intended to be limiting to the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present invention and will not be interpreted in an idealized or overly formal sense unless expressly so defined herein.

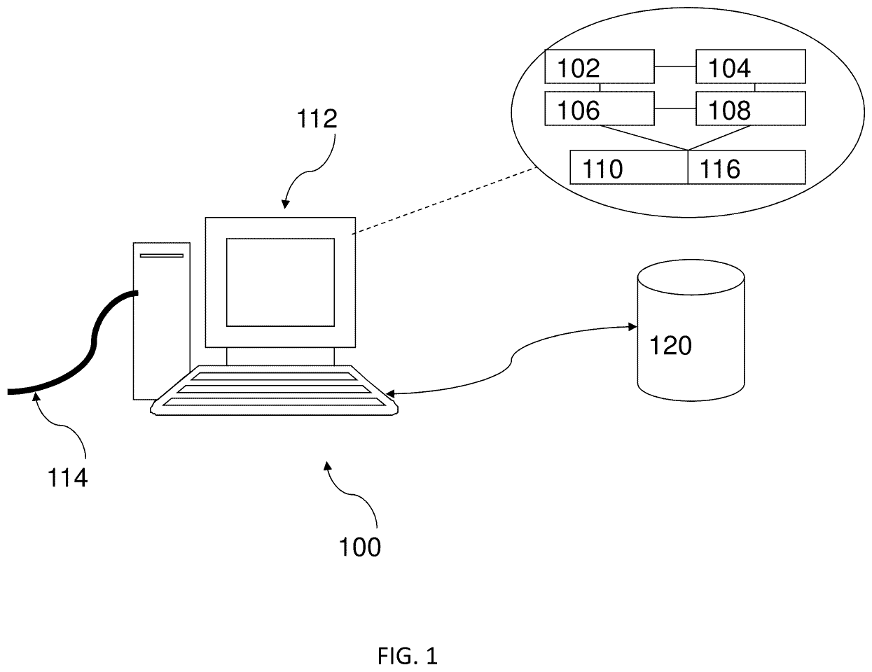

Referring to FIG. 1, an embodiment of the present invention is illustrated. This embodiment is arranged to provide a system for implementing a method of enhancing dataset for use in a medical diagnostic system, comprising the step of: receiving a static medical image capturing a diagnostic target; and generating, based on the received static medical image, a series of video frames arranged to combine to a dynamic video representing a clinical motion of the diagnostic target over a predetermined period of time; wherein the dynamic video is adapted to be included in a medical dataset for training the medical diagnostic system. In addition, the system may also be used for synthesizing video for medical diagnosis, by providing a static medical image capturing a diagnostic target; and generating a series of video frames based on the static medical image provided.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

The system may be used to receive a static image capturing a diagnostic target, such as mucosal surface, wall of an organ, some abnormal tissues, etc., and then a series or sequence of image/video frames may be generated, each having a slight difference or variation when compared to the adjacent frame, and thus may be combined to a video clip, when the image frames are displayed in sequence. For the purpose of training a neural network processing engine such as a machine learning based medical diagnostic system, the generated video clip may be labelled with associated analysis or diagnostic results provided by medical experts or practitioners, thereby suitable classifier may be trained. In some examples, robustness of the neural network processing engine may further be trained with unlabeled video or generated video which may prevent class imbalance.

As shown in FIG. 1, a schematic diagram of a computer system or server, labeled 100, is presented. This diagram represents an example embodiment of a processor within the server which is capable of performing the method of enhancing dataset for use in a medical diagnostic system. In this embodiment, the system comprises a server 100 which includes suitable components necessary to receive, store and execute appropriate computer instructions. The components may include a processing unit 102, including Central Processing Unit (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display, or any other suitable display and communications links 114. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IOT) devices, smart devices, edge computing devices, cloud devices. At least one of a plurality of communications links may be connected to an external computing network through a telephone line or other type of communications link.

The server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service 120. The server 100 may also have a suitable operating system 116 which resides on the disk drive or in the ROM of the server 100.

The computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

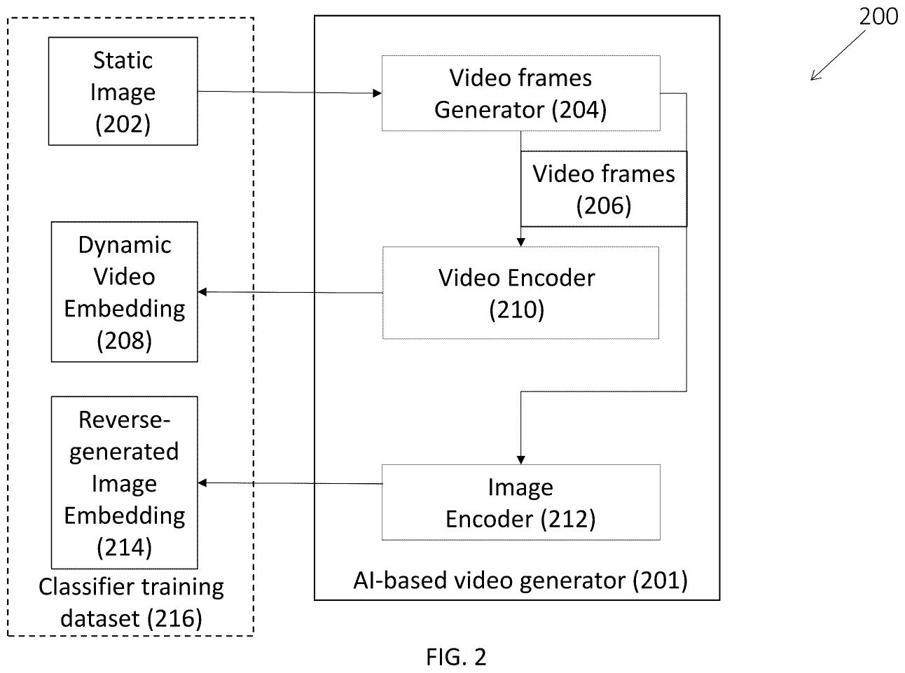

With reference to FIG. 2, an embodiment of the method of enhancing dataset for use in a medical diagnostic system, in particular, generating or synthesizing video for medical diagnosis, labelled 200, is shown. In this embodiment, a series of video frames may be generated by an AI-based video generator, simply by providing a single static image to the medical diagnostic system, in which the series of video frames can be combined (e.g. after suitable encoding) to a dynamic video that illustrates the captured diagnostic target with clinical motion includes at least one of spatial translation, liquid flow and shake blur, or other types of motion which may be observed in other clinical video records.

For example, a static image showing a part of the digestive tract of a patient may be provided to the system for generating a video embedded with movement of that particular part of the digestive tract. The video may be further review or analyzed by a medical practitioner to identify one or more medical condition of the patient, in relation to that part of the digestive tract, such as existence of inflammation or tumor, based on the observation and professional judgement of the medical practitioner by observing the static image and the dynamic video generated based on the static image.

Referring to FIG. 2, in one example operation, a static image 202 is provided to the AI-based video generator 201, which comprises a video frames generator 204 that generates a plurality of video frames 206, the video frames 206 may be combined to a dynamic video 208 showing a movement of the diagnostic target captured by the static image 202 using a video encoder 210. In addition, the dynamic video 208 may be further processed by an image encoder 212 for generating a plurality of reverse-generated image embeddings 214 which is similar to the plurality of video frames generated earlier, but may further embed with motion-aware semantic or information based on the generated dynamic video 208.

In this example, the static image 202, generated dynamic video 208 and the reversed-generated images 214 may be included in a classifier training dataset 216. Preferably a comprehensive training dataset may comprise a plurality of each of the static images 202 and the respective dynamic video and set of reversed-generated images 214. Each set of the training component 202, 214 and 208 may be labelled or unlabeled, as further explained in a later part of this invention. In addition, in some exemplary embodiment, a machine-learning classifier may be trained only with the images without the dynamic video 208 since the motion-aware semantic has been embedded in the reverse-generated images generated based on the dynamic video 208.

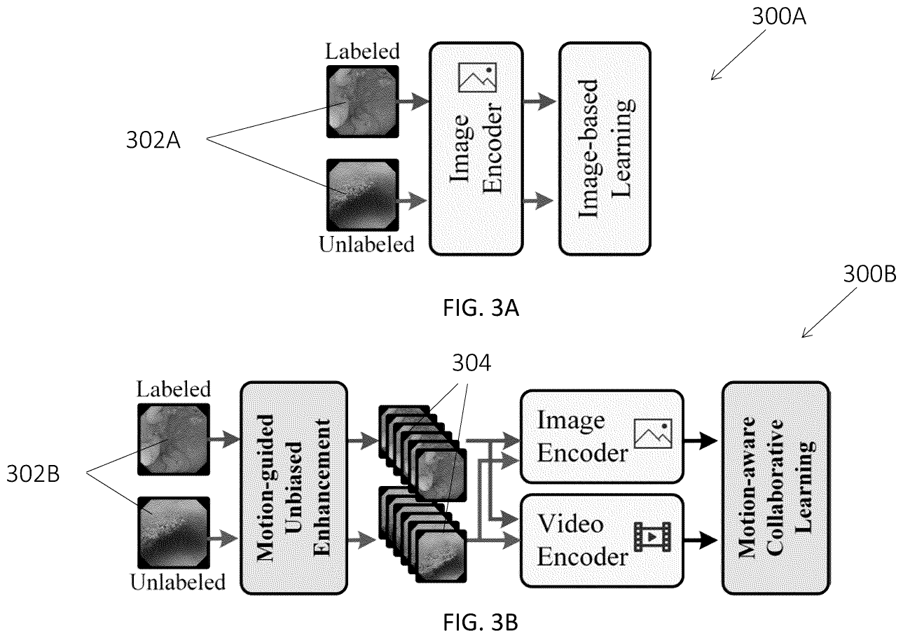

With reference to FIGS. 3A and 3B, there is shown two different example embodiments of training a learning network, based on database with static images initially. In the example referring to FIG. 3A, the inventors devised that the network 300A would fail to capture video-based dynamics, since the model merely generates static images based on input static images 302A. In contrast, compared with static images, the dynamic motions captured in videos, e.g., subtle movements of mucosal surfaces, contractile patterns of organ walls, and the dynamic interaction between instruments and tissues, provide invaluable information in clinical assessment. Preferably, the meticulous understanding and distillation of video-based motion patterns may be imperative for enhancing medical image analysis and therapeutic strategies, and may result in a better diagnosis system 300B being trained, as shown in FIG. 3B, in which, sets of static images 302B may be first transformed to become dynamic video 304, using a motion-guided unbiased enhancement process 306 to enrich the training dataset by providing not just static images but also multiple image frames of a dynamic video 304 with movements or motions for training.

In addition, the generated dynamic video may be further reversed encoded to become multiple images embedded with motion semantics, for the later machine learning process called “motion-aware collaborative learning”, in which both enhanced reversed generated images and the dynamic video streams are included in a machine learning training dataset.

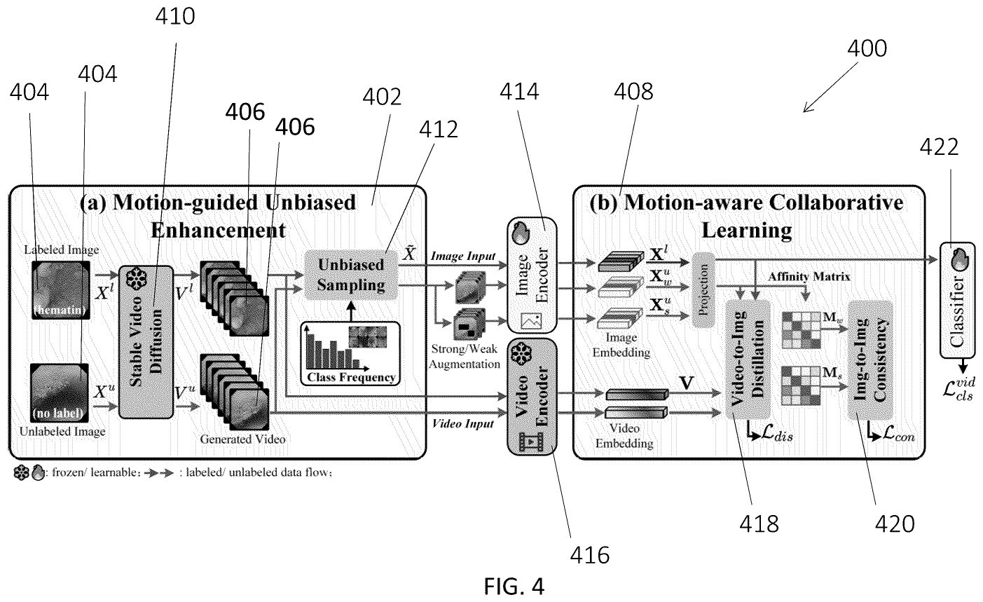

With reference to also to FIG. 4, the VidMotion example 400 is further explained as follows. Preferably, VidMotion 400 may consist of Motion-guided Unbiased Enhancement (MUE) module 402 to augment static images 404 with generative medical videos unbiasedly and Motion-aware Collaborative Learning (MCL) module 408 to capture the video dynamics. Preferably, MUE 402 enhances medical images 404 into short videos 406 enriched with diverse clinical motions and conducts unbiased sampling to gather reliable frames statistically. Then, MCL 408 deploys video-to-image distillation 418 and image-to-image consistency 420 to capture the motion-based semantics, thereby improving the diagnosis with video dynamics using the classifier 422 trained by the enhanced training dataset.

Considering that the generated videos 406 can boost various types of data, in an example experiment conducted by the inventors, VidMotion 400 was evaluated with the semi-supervised learning (SSL) diagnosis benchmark, i.e., a clinically practical setting using labeled data and unlabeled data, to thoroughly assess the capacity of both supervised and unsupervised scenarios. Extensive experiments verify that VidMotion significantly surpasses alternative embodiments employing SOTA methods. Besides methodology contributions, the synthesized high-quality videos can contribute to medical research greatly.

As previously described, preferably, the dynamic video 406 or the video frames may be generated using a Stable Video Diffusion process, in which a predetermined number of N video frames may be generated by the AI-based video generator 201. In SSL, labeled data

$${X}^{l} = {\{ ( {x}_{i}^{l} , {y}_{i}^{l} ) \}}_{i = 1}^{{B}_{l}}$$

and unlabeled data

$${X}^{u} = {\{ ( {x}_{i}^{u} ) \}}_{i = 1}^{{B}_{u}}$$

is provided to train the model, where Bₗ and Bᵤ denotes the corresponding batch size. With reference to FIG. 4, given the labeled and unlabeled data {X^{l}, X^{u}}, MUE may first leverages the frozen (i.e. not learning-based) Stable Video Diffusion model 410 to generate N video frames {V^{l}, V^{u}} for each image, and then conducts unbiased sampling 412 to collect a sub-set of video frames X^{l/u} ⊂V^{l/u}. Next, the sampled video frames V^{l/u} and complete video streams V^{l/u} are sent to a learnable image encoder 414 and frozen video encoder 416 to generate image

$${\tilde{X}}^{l / u} = {\{ {x}_{i , k} \}}_{i = 1 ; k = 1}^{B , K}$$

and video embedding

$${V}^{l / u} = {\{ {v}_{i} \}}_{i = 1}^{B} ,$$

respectively, where K is the number of sampled frames. Finally, MCL 408 distills motion semantics from videos to boost the image representation, so that the “reverse-generated” (i.e. static image to dynamic video and back to image) images are obtained.

In preferred embodiments of the present invention, different from using static images, synthesize medical videos with motion semantics are included, which may be crucial for enhancing model robustness against clinical motions, e.g., the instrument movements. Preferably, stable video diffusion may be used to synthetic videos from referenced images, the process may create multiple frames from a single static image, in which a static image serving as the initial frame for the later generated video is mapped to a high-dimensional space called the latent space. In this space, similar images are close together, and different images are far apart. A diffusion process is then performed in the latent space, this process may involve gradually changing the position in the latent space over time, following a random path that is guided by the Stable video diffusion model's learned dynamics. At each step of the diffusion process, the model maps the current position in the latent space back to an image, creating a new frame for the video. Stable video diffusion may also be trained to ensure temporal consistency between frames, meaning that consecutive frames should form a smooth and coherent video sequence. The final output may be a sequence of frames that transitions smoothly from the initial image, creating the illusion of motion.

In one exemplary embodiment, the generation process may be formulated with a diffusion process in a Markov chain, which can generate video data v₀ from the noise V_{T}˜ [symbol] (0,1) via a T—step denoising process guided by a specific condition. In this process, the labeled and unlabeled data {X^{l}, X^{u}} was used as the diffusion condition to guide the generation, which can ensure semantic and spatial consistency. The generation process is denoted as follows,

$${p}_{θ} ( {v}_{0 : T} \vert {x}^{l / u} , γ ) = p ( {v}_{T} ) {\prod }_{t = 1}^{T} {p}_{ϕ} ( {v}_{t - 1} \vert {v}_{t} , {x}^{l / u} , γ ) \qquad ( 1 )$$

where ϕ is the pre-trained Stable Video Diffusion model, which is preferably a frozen model or process, p_{ϕ}( ) indicates the estimated conditional distribution for generated medical videos, γ∈[0,255] is a constant controlling the motion intensity of generated videos. Then, for each image batch

$${X}^{l / u} = {\{ {x}_{i}^{l / u} \}}_{i = 1}^{B} ,$$

a set of synthesized videos

$${V}^{l / u} = {\{ {x}_{i = 1}^{l / u} \}}_{i = 1}^{B}$$

are obtained to model diverse motions, where

$${v}_{i}^{l / u} = \{ ( {v}_{i}^{l / u} , {x}_{i , 2}^{l / u} , {x}_{i , 3}^{l / u} , … , {x}_{i , N}^{l / u} ) \}$$

indicates the video frames generated by image

$${x}_{i}^{l / u} ,$$

and N is the number of frames. Preferably, a plurality of static medical images are provided as sample images each captures the respective diagnostic target, and wherein the sample images are processed by the stable video diffusion process, to obtained a set of synthesized videos, wherein each of the synthesized video comprises the N video frames generated by the each of the sample images being augmented.

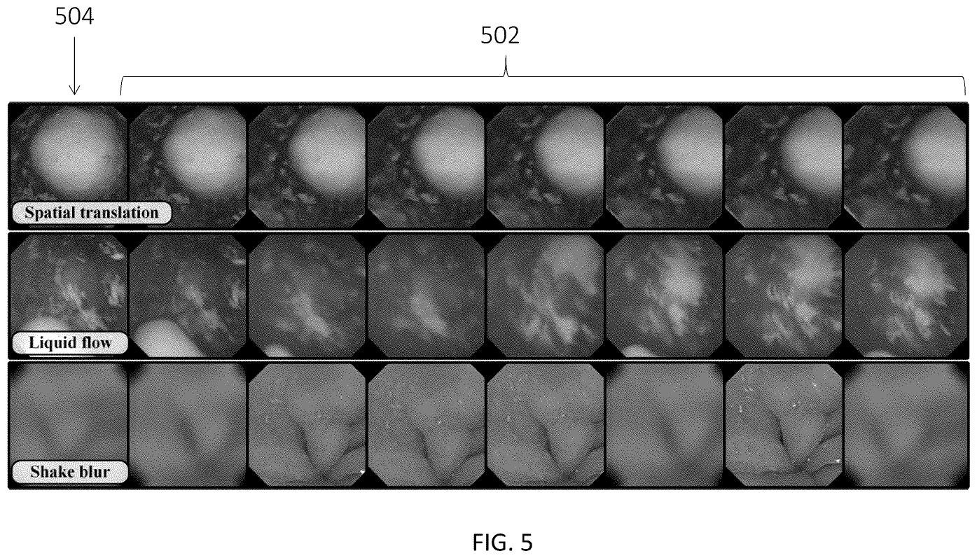

In example experiments, it was found that generated videos may adhere to satisfactory physical rationality, effectively simulating various motions in clinical practice, e.g., spatial translation, liquid flow, shake blur, etc, as further illustrated in FIG. 5.

Preferably, the sample images including labelled and unlabeled medical images capturing a respective diagnostic target. As medical data significantly suffers from class imbalance, the rare cases are overshadowed by an abundance of common cases, detrimentally influencing model learning and diagnosis accuracy. This issue becomes more pronounced when scaling up the data with videos since the more prevalent classes yield a more significant number of video frames with larger diversity. To avoid such negative influence, a simple yet effective mechanism may be employed to conduct unbiased sampling on the generated video frames according to the class distribution prior.

Specifically, given C classes with Nc labeled samples for class c, a subset of video frames \tilde{X}^{l/u} may be collected with the guidance of the class frequency:

$${\tilde{X}}^{l / u} = RandomSample ( {V}^{l / u} , ⌈ α \cdot \vert {V}^{l / u} \vert ⌉ ) , where α = \frac{\frac{1}{{N}_{c}}}{{\sum }_{j = 1}^{c} \frac{1}{{N}_{j}}} , \qquad ( 2 )$$

and V={vᵢ} is all synthesized videos. Thus, the unbiased sampling tends to collect more video frames for the rare classes and vice versa, which is critical in encouraging unbiased model learning without clinic and diagnosis bias.

Preferably, the series of video frames are generated based on augmentation of the static medical image. With the generated videos V^{l/u} and the sampled image frames \tilde{X}^{l/u}, collaborative learning between the image and video modalities may be conducted. Considering that the video contains rich temporal information and motion cues, the model is encouraged to generate motion-robust predictions for clinical practice. Specifically, the sampled video frames ŘI/u with |\tilde{X}^{l/u}|=K_{l/u} are sent to the image encoder to generate image embedding X, where the labeled data yields X^{l}∈ [symbol] and the unlabeled data is conducted strong/weak augmentation to yield

$${X}_{s}^{u} and {X}_{w}^{u} ,$$

where

$${X}_{s / w}^{u} ∈ {ℝ}^{{B}_{u} \times {K}_{u} \times {D}^{′}} .$$

At the same time, generated videos V^{l/u} may be sent to a pre-trained video encoder to encode temporal-aware knowledge, yielding the video embedding V^{l/u} ∈ [symbol] . In this example, the pre-trained video encoder is frozen and is not evolving like “learning” models or processes.

Preferably, the method further comprising the step of generating, based on the dynamic video being generated, a series of reversed-generated images embedding inherent motion information associated with the diagnostic target over the predetermined period of time; wherein the series of reversed-generated images is arranged to be included in the medical dataset for training the medical diagnostic system.

For example, the series of reversed-generated images and the dynamic video may be processed using a video-to-image distillation process to distill motion-aware cue information from the dynamic video, preferably, the video-to-image distillation process comprises the steps of: scaling up a dimension of each of the series of reversed-generated images to obtain more representative space; and distilling motion-aware cue information from the dynamic video to associated image frames with a loss function.

To extract the inherent motion cues at the temporal axis, embedding distillation may be employed to transfer the video semantics to the image counterpart, enabling motion perception in the image branch. To this end, given the video embedding V and the image embedding X, an MLP projection layer may be first applied on the image embedding to scale up the dimension for more representative space. As the same operations may be deployed for labeled and unlabeled samples, the superscripts (l/u) of the embedding are not added for mathematical clarity. Then, the motion-aware cues may be distilled from the video embedding to associated image frames with Li loss, which is denoted as follows,

$${L}_{d i s} = \frac{1}{B \times K \times D} {\sum }_{b = 1}^{B} {\sum }_{k = 1}^{K} {\sum }_{d = 1}^{D} {\vert \frac{{MLP ( X )}_{[ b , k , d ]}}{\vert MLP ( X ) \vert} - \frac{{v}_{[ b , d ]}}{\vert V \vert} \vert}_{1} . \qquad ( 3 )$$

This cross-modality distillation can transfer the temporary semantics to the image model, thereby ensuring the motion robustness of the learned embedding.

In addition, the reversed generated images may be further processed to enhancing cross-image consistency within imaging modality of the series of reversed-generated images, in which a plurality pairs of reversed-generated images in the series of reversed-generated images associated with each video frame pair in the dynamic video are enhanced via consistency loss.

To harness the abundant inter-frame dependencies for reliable model recognition, cross-image consistency may be further enhanced within the imaging modality. Thus, the model may be enabled to leverage the rich temporal knowledge within video sequences. Specifically, given the image embedding of strong/weak augmented unlabeled data X_{s/w}^{u}, ∈ [symbol] , the former MLP projection layers may be used to generate embedding and then calculate the pair-wise cosine similarity to generate affinity matrix

$${M}_{s / w}^{u} = \frac{{{x}_{s / w}^{u} ( {x}_{s / w}^{u} )}^{T}}{{‖ {x}_{s / w}^{u} ‖}_{2} \cdot {‖ {x}_{s / w}^{u} ‖}_{2}} , {M}_{s / w}^{u} ∈ {ℝ}^{{B}_{u} \times {K}_{u} \times {K}_{u}} ,$$

then, the consistency between the affinity matrix obtained from the strong and weak augmented samples may be encouraged, as expressed below,

$${L}_{c o n} = \frac{1}{{B}_{u} \times {K}_{u} \times {K}_{u}} {\sum }_{i = 1}^{{B}_{u}} {\sum }_{j = 1}^{{K}_{u}} {\vert {M}_{s [ b , k ]}^{u} - {M}_{w [ b , k ]}^{u} \vert}_{2} . \qquad ( 4 )$$

Different from alternative examples of medical diagnosis system that typically process images independently, in the method according to embodiments of the present invention, the relation within each video frame pair can be thoroughly enhanced via the consistency loss, boosting the image model with long-distance dependence among different video frames.

The present invention also provides a method for training a medical diagnostic system, comprising the step of training a classifier, such as the classifier in the embodiment as shown in FIG. 4, with the medical dataset comprising the dynamic video and/or the series of reversed-generated images. In this example, at least a portion of the training data, such as the dynamic video and the series of reversed-generated images generated as abovementioned, are labelled for training the classifier.

In the training stage of VidMotion, the following loss function may be implemented:

$$ℒ = {λ}_{1} {L}_{dis} + {λ}_{2} {L}_{con} + {L}_{cls}^{vid} + {L}_{base} \qquad ( 5 )$$

where L_{dis} is the video-to-image distillation loss, L_{con} is the image-to-image consistency, L^{vid} is the standard classification loss for sampled video frames, and L_{base} can be deployed as any image-based SSL baseline. As video generation does not change the semantic-level role of the given image, a consistent label may be directly assigned to the generated video frames.

Preferably, the classifier and/or the image encoder is trained the series of reversed-generated images and embedded with motion-aware cue information, without any video-related components. For example, in the inference stage, the image encoder and classifier, which may be preferably provided as a machine learning network, may be implemented without any video-related components, such as the generated dynamic video per se, because video-based semantics have been distilled to image models.

TABLE 1
Comparison with SOTA methods on Kvasir-Capsule and ISIC 2018 datasets

| | 5% | | | 10% | | | 20% | | | 40% | | |
|---|---|---|---|---|---|---|---|---|---|---|---|---|
| Method | MAP | MAR | AUC | MAP | MAR | AUC | MAP | MAR | AUC | MAP | MAR | AUC |

Kvasir-Capsule: Endoscopic Scene

| | | | | | | | | | | | | |
|---|---|---|---|---|---|---|---|---|---|---|---|---|
| FixMatch | 66.77 | 56.84 | 76.83 | 69.36 | 58.59 | 78.04 | 80.75 | 68.88 | 83.39 | 85.87 | 76.51 | 87.54 |
| CoMatch | 68.11 | 63.22 | 80.44 | 73.80 | 65.19 | 81.71 | 82.74 | 71.30 | 84.74 | 86.07 | 79.88 | 89.15 |
| SimMatch | 67.25 | 65.69 | 81.77 | 70.43 | 71.37 | 84.56 | 82.24 | 70.44 | 84.58 | 86.81 | 81.25 | 89.95 |
| TEAR | 67.46 | 65.71 | 81.65 | 69.83 | 72.36 | 82.23 | 82.35 | 73.28 | 85.99 | 87.78 | 80.94 | 90.02 |
| ACPL | 70.17 | 67.21 | 81.97 | 74.73 | 66.46 | 82.33 | 83.42 | 74.45 | 86.52 | 87.41 | 82.76 | 90.85 |
| SimMatchV2 | 70.96 | 65.99 | 81.78 | 74.91 | 75.29 | 84.20 | 84.34 | 75.08 | 86.79 | 87.91 | 85.31 | 92.11 |
| VidMotion | 73.55 | 69.96 | 83.75 | 78.28 | 77.57 | 87.91 | 86.05 | 79.89 | 89.34 | 91.21 | 86.41 | 92.70 |

ISIC 2018 Skin Lesion: Dermoscopic Scene

| | | | | | | | | | | | | |
|---|---|---|---|---|---|---|---|---|---|---|---|---|
| FixMatch | 37.61 | 25.49 | 57.47 | 38.04 | 30.27 | 60.60 | 43.78 | 37.80 | 64.73 | 49.32 | 41.06 | 66.75 |
| CoMatch | 39.04 | 25.95 | 57.84 | 39.77 | 29.45 | 60.22 | 45.51 | 37.84 | 65.15 | 50.29 | 41.29 | 67.27 |
| SimMatch | 39.25 | 26.09 | 58.71 | 41.05 | 30.00 | 60.65 | 44.87 | 39.49 | 65.81 | 51.77 | 42.64 | 67.21 |
| TEAR | 40.90 | 25.61 | 57.95 | 42.00 | 30.60 | 61.34 | 45.20 | 39.71 | 65.73 | 50.55 | 41.73 | 67.24 |
| ACPL | 41.67 | 25.07 | 57.44 | 43.42 | 32.24 | 62.14 | 45.29 | 38.06 | 65.19 | 51.76 | 42.49 | 68.11 |
| SimMatchV2 | 41.50 | 27.61 | 58.90 | 43.82 | 33.05 | 62.42 | 46.38 | 38.14 | 65.31 | 51.72 | 43.92 | 68.43 |
| VidMotion | 44.25 | 28.16 | 59.76 | 45.46 | 34.55 | 63.24 | 47.14 | 42.25 | 67.37 | 54.19 | 46.39 | 69.71 |

In the following evaluation experiment, methods on two public benchmarks with extensive settings were tested. (1) Kvasir-Capsule. KC is a real-world endoscopic dataset containing 47,238 images with 14 challenging clinic classes. The subset was randomly collected for the model training and test for fair comparison. (2) ISIC 2018. ISIC 2018 is a real-world skin lesion dataset, which consists of 10,015 dermoscopy images. ISIC contains seven kinds of different skin lesions, which is a more challenging dataset with the intrinsic class-imbalanced issue. Different from relying on the class-balanced data splitting, four different SSL settings with 5%, 10%, 20% were used, and 40% label regimes according to the real class distribution for more clinical rationality.

To thoroughly evaluate SSL in real-world situations, three evaluation metrics were used for strict comparison, including Macro-Average Precision (MAP), Macro-Average Recall (MAR), and multi-class Area Under Curve (AUC), where MAP and MAR can better evaluate imbalanced medical scenarios, and AUC can better analyze the general performance in the balanced situation.

All methods on WideResNet-22 image encoder were used and the pretrained CLIP-ViP video encoder was deployed. For video generation, SVD-XT was used to generate N=25 video frames for each medical image with T=25, which is performed on NVIDIA A100 GPUs. The motion intensity γ is set to 255 to maximize the motion diversity.

Considering the computation cost, 5% ratio of data was randomly used for the video generation. For the learnable components, all the models were trained with 100 epochs and SGD optimizer with the learning rate of 1×10⁻², a momentum of 0.9, a weight decay of 5×10⁻⁴, and cosine annealing training schedule was deployed. Experiments are performed on NVIDIA 2080 Ti GPUs with Nₗ=12 and Nᵤ=84. The data input settings and strong/weak augmentations are consistent with the baseline model, CoMatch, for a fair comparison. The loss weights 11 and 12 in Eq. 5 are empirically set as 0.1 and 1.0, respectively.

As shown in Table 1, VidMotion was compared with example SSL methods with different label regimes. Compared with the SimMatchV2, VidMotion achieves consistent and noticeable gains on all evaluation matrices, which performs 2.59%, 3.37%, 1.71%, and 3.3% MAP gains, and gives 1.97%, 3.71%, 2.06%, and 0.69% AUC improvements. This indicates that VidMotion is highly effective and robust to the data distribution with great generalization capacity. In comparison with other SSL methods in the field of medical imaging, VidMotion surpasses TEAR and ACPL with 2.10% and 1.97% AUC (5%), respectively, showing strong capacity of VidMotion under data-efficient learning.

Detailed ablation analysis is shown in Table 2 below, on each designed component, evaluated on two benchmarks under two different label regimes. Compared with the baseline model with 68.11%, 86.07% 39.04%, and 50.29% MAP, introducing video-enhanced data for training (MUE) gives significant performance gains with 71.87%, 88.77%, 43.22%. and 53.10% MAP, verifying the critical motion-based semantics. Then, after introducing MCL with V2I and 12I, it is observed that noticeable performance improvements with 73.55%, 91.21%, 44.25%, and 54.19% MAP, which surpasses the baseline model with significant 5.44%, 5.41%, 5.21%, and 3.90% MAP improvements, revealing the superior effectiveness of the collaborative learning paradigm of VidMotion.

TABLE 2
Ablation study results on Kvasir-Capsule and ISIC 2018 datasets

| Setting | | | Kvasir-Capsule | | | | | | ISIC 2018 Skin Lesion | | | | | |
|---|---|---|---|---|---|---|---|---|---|---|---|---|---|---|
| | MCL | | 5% | | | 40% | | | 5% | | | 40% | | |
| MUE | V2I | I2I | MAP | MAR | AUC | MAP | MAR | AUC | MAP | MAR | AUC | MAP | MAR | AUC |
| X | X | X | 68.11 | 63.22 | 80.44 | 86.07 | 79.88 | 89.15 | 39.04 | 25.95 | 57.84 | 50.29 | 41.29 | 67.27 |
| ✓ | X | X | 71.87 | 65.72 | 81.48 | 88.77 | 82.33 | 90.54 | 43.22 | 26.62 | 58.71 | 53.10 | 44.10 | 68.63 |
| ✓ | ✓ | X | 72.51 | 68.40 | 83.06 | 91.03 | 84.35 | 91.02 | 44.02 | 27.23 | 59.01 | 53.14 | 45.23 | 69.02 |
| ✓ | ✓ | ✓ | 73.55 | 69.96 | 83.75 | 91.21 | 86.41 | 92.70 | 44.25 | 28.16 | 59.76 | 54.19 | 46.39 | 69.71 |

To further analyze VidMotion, a detailed sensitivity analysis on the core hyper-parameters was also conducted. In Table 3, if the loss weight was decreased with/1=0.05 and −2=0.5, there is a small performance decrease (−1.05% and −0.77% MAP) compared with an optimal setting, indicating the effectiveness of VidMotion. In Table 4, it is shown that VidMotion is robust to the motion intensity and gives slight gains when the γ was enlarged due to more diverse motion types.

TABLE 3
Sensitivity on loss weight λ.

| λ₁ | λ₂ | MAP | MAR | AUC |
|---|---|---|---|---|
| 0.1 | 1.0 | 73.55 | 69.96 | 83.75 |
| 0.2 | 1.0 | 74.01 | 69.31 | 82.97 |
| 0.1 | 2.0 | 73.12 | 69.42 | 82.23 |
| 0.05 | 1.0 | 72.96 | 68.88 | 82.12 |
| 0.1 | 0.5 | 73.24 | 69.02 | 83.01 |

TABLE 4
Sensitivity on motion γ.

| γ | MAP | MAR | AUC |
|---|---|---|---|
| 55 | 72.11 | 68.33 | 82.07 |
| 105 | 72.48 | 69.02 | 83.03 |
| 155 | 73.03 | 69.11 | 83.38 |
| 205 | 73.21 | 69.33 | 83.42 |
| 255 | 73.55 | 69.96 | 83.75 |

As shown in FIG. 5, the video frames 502 generated by the static images 504 in three different classes. The left-most image 504 in each row represents the reference image for the image-to-video generation. The generated videos not only adhere to the laws of physical motion but also successfully simulate diverse movements encountered in clinical environments. These include but are not limited to spatial translations, fluid dynamics, and vibrational motions with shaking bur. Furthermore, the robustness of video generation of VidMotion is evidenced by its ability to produce high-fidelity visuals across a diverse set of classes.

These embodiments were advantageous in that, a method incorporating a holistic framework named VidMotion is provided to boost medical image analysis with generative medical videos, which breaks through the static diagnosis in existing works by learning with dynamic videos. VidMotion consists of a Motion-guided Unbiased Enhancement module to augment medical images into motion-informed videos at the data level. Besides, it designs a Motion-aware Collaborative Learning module to encourage the joint learning of the image and video embedding.

Extensive experiments verify that the method is both highly effective and efficient, which surpasses SOTA methods by a large margin.

Advantageously, VidMotion consists of a Motion-guided Unbiased Enhance-ment (MUE) to augment static images into dynamic videos at the data level and a Motion-aware Collaborative Learning (MCL) module to learn with images and generated videos jointly at the model level, so as to boost medical image analysis with generative medical videos.

Specifically, MUE first transforms medical images into generative videos enriched with diverse clinical motions, which are guided by image-to-video generative foundation models. In addition, an unbiased sampling strategy informed by the class distribution prior statistically, thereby extracting high-quality video frames, to avoid the potential clinical bias caused by the imbalanced generative videos.

In MCL, joint learning with the image and video representation, including a video-to-image distillation and image-to-image consistency, may be performed to fully capture the intrinsic motion semantics for motion-informed diagnosis. The method has been validated on extensive semi-supervised learning benchmarks and it is observed that VidMotion is highly effective and efficient, outperforming other example approaches significantly.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of specific functions, the skilled person will understand that the functionality of the software application may be distributed across a number of routines, objects, or components to achieve the same functionality desired herein.

It will also be appreciated that where the methods and systems of the present invention are either wholly implemented by computing systems or partly implemented by computing systems then any appropriate computing system architecture may be utilized. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A method of enhancing dataset for use in a medical diagnostic system, comprising the step of:
receiving a static medical image capturing a diagnostic target; and
generating, based on the received static medical image, a series of video frames arranged to combine to a dynamic video representing a clinical motion of the diagnostic target over a predetermined period of time;
wherein the dynamic video is adapted to be included in a medical dataset for training the medical diagnostic system.

2. The method of claim 1, wherein the series of video frames are generated by an AI-based video generator.

3. The method of claim 2, wherein the series of video frames are generated based on augmentation of the static medical image.

4. The method of claim 3, wherein the step of generating the series of video frames comprises the step of generating N video frames using a Stable Video Diffusion process.

5. The method of claim 4, wherein stable video diffusion process is formulated with a Markov chain, arranged to generate video data from noise in the static medical image via a T-step denoising process.

6. The method of claim 5, wherein a plurality of static medical images are provided as sample images each captures the respective diagnostic target, and wherein the sample images are processed by the stable video diffusion process, to obtained a set of synthesized videos, wherein each of the synthesized video comprises the N video frames generated by the each of the sample images being augmented.

7. The method of claim 6, wherein the sample images including labelled and unlabeled medical images capturing a respective diagnostic target.

8. The method of claim 1, wherein the clinical motion includes at least one of spatial translation, liquid flow and shake blur.

9. The method of claim 1, further comprising the step of generating, based on the dynamic video being generated, a series of reversed-generated images embedding inherent motion information associated with the diagnostic target over the predetermined period of time; wherein the series of reversed-generated images is arranged to be included in the medical dataset for training the medical diagnostic system.

10. The method of claim 9, further comprising the step of processing the series of reversed-generated images and the dynamic video using a video-to-image distillation process to distill motion-aware cue information from the dynamic video.

11. The method of claim 10, wherein the video-to-image distillation process comprises the steps of:
scaling up a dimension of each of the series of reversed-generated images to obtain more representative space; and
distilling motion-aware cue information from the dynamic video to associated image frames with a loss function.

12. The method of claim 10, further comprising the step of enhancing cross-image consistency within imaging modality of the series of reversed-generated images.

13. The method of claim 12, wherein a plurality pairs of reversed-generated images in the series of reversed-generated images associated with each video frame pair in the dynamic video are enhanced via consistency loss.

14. A method for training a medical diagnostic system in accordance with claim 9, comprising the step of training a classifier with the medical dataset comprising the dynamic video and/or the series of reversed-generated images.

15. The method of claim 14, wherein the dynamic videos are labelled.

16. The method of claim 14, further comprising the step of training an image encoder arranged to generated the series of reversed-generated image embeddings based on the dynamic video.

17. The method of claim 16, wherein the classifier and/or the image encoder is a machine learning network.

18. The method of claim 16, wherein the classifier and/or the image encoder is trained the series of reversed-generated images and embedded with motion-aware cue information, without any video-related components.

19. A method of synthesizing video for medical diagnosis, comprising the step of:
providing a static medical image capturing a diagnostic target; and
generating a series of video frames using the method in accordance with claim 1.

20. The method of claim 19, further comprising the step of generating a dynamic video with the series of video frame using a frozen video encoder.
